(19) United States
(12) Patent Application Publication
(10) Pub. No.: US 2026/0125076 A1
(43) Pub. Date: May 7, 2026

(54) CONTROL APPARATUS FOR VEHICLES

(71) Applicant: DENSO CORPORATION, Kariya-city (JP)

(72) Inventors: Hiroshi YOSHIDA, Kariya-city (JP); Mitsuharu HIGASHITANI, Kariya-city (JP); Noriaki IKEMOTO, Kariya-city (JP)

(73) Assignee: DENSO CORPORATION, Kariya-city (JP)

(21) Appl. No.: 19/375,441

(22) Filed: Oct. 31, 2025

(30) Foreign Application Priority Data
Nov. 6, 2024 (JP) 2024-194469

(51) Int. Cl. B60W 60/00

(52) U.S. Cl. CPC B60W 60/001

(57) ABSTRACT

A control apparatus operates a control target included in a vehicle that travels along a scheduled travel route and automatically controls, based on an operation of the control target, a predetermined physical quantity so as to bring the predetermined physical quantity closer to a control target value, thus adjusting energy consumption of the vehicle. In the control apparatus, a storage stores, in advance, at least one waypoint located on the scheduled travel route and a waypoint-corresponding target value associated with the at least one waypoint. Control circuitry causes the control apparatus to determine whether the vehicle has reached the at least one waypoint, and determine the waypoint-corresponding target value as the control target value in response to determination that the vehicle has reached the at least one waypoint.

### CROSS-REFERENCE TO RELATED APPLICATION

This present application is based on and claims the benefit of priority from Japanese Patent Application No. 2024-194469 filed on November 6, 2024, the disclosure of which is incorporated herein by reference.

### TECHNICAL FIELD

The present disclosure relates to control apparatuses for vehicles.

### BACKGROUND

Japanese Patent Publication No. 3664219 discloses a navigation apparatus. The navigation apparatus disclosed in the patent publication detects coordinates of a current position of a vehicle, and calculates a linear line that passes through detected coordinates of a destination and is orthogonal to a detected vehicle’s azimuth direction at the destination. Then, the navigation apparatus calculates a distance between the linear line and the current position of the vehicle as a distance from the current position of the vehicle to the destination. The patent publication describes that the vehicle can properly decelerate when approaching the destination.

### SUMMARY

In recent years, there has been a growing demand for extending the cruising range of vehicles while maintaining occupant comfort. To address this demand, automatic control technologies for appropriately adjusting the energy consumption of vehicles have become increasingly important.

However, although prior art documents, such as the patent publication, relate to automatic control of vehicles, they do not disclose techniques for dynamically adjusting vehicle energy consumption to optimize the cruising range.

The inventors of the present disclosure have found the above circumstances.

In view of the above circumstances, the present disclosure seems to provide control apparatuses for a vehicle, each of which is capable of dynamically adjusting energy consumption of the vehicle in accordance with the vehicle’s travel progress on a scheduled travel route.

An exemplary aspect of the present disclosure provides a control apparatus. The control apparatus is configured to operate a control target included in a vehicle that travels along a scheduled travel route and to automatically control, based on an operation of the control target, a predetermined physical quantity so as to bring the predetermined physical quantity closer to a control target value, thus adjusting energy consumption of the vehicle. The control apparatus includes a storage configured to store, in advance, at least one waypoint located on the scheduled travel route and a waypoint-corresponding target value associated with the at least one waypoint. The control apparatus includes control circuitry configured to cause the control apparatus to determine whether the vehicle has reached the at least one waypoint, and determine the waypoint-corresponding target value as the control target value in response to determination that the vehicle has reached the at least one waypoint.

This configuration of the control apparatus adjusts the physical quantity at the at least one waypoint, making it possible to dynamically adjust energy consumption of the vehicle in accordance with a travel progress of the vehicle along the scheduled travel route.

That is, the control apparatus is capable of dynamically adjusting energy consumption of the vehicle in accordance with how far the vehicle has traveled along the scheduled travel route, making it possible to achieve both the securing of occupant comfort and the reduction of energy consumption of the vehicle.

Where reference characters are used in parentheses for various elements throughout the present disclosure, such characters are provided merely as an example of the correspondence between the elements and the specific structures in the embodiments described later. The present disclosure is therefore not limited by the use of such reference characters.

### BRIEF DESCRIPTION OF THE DRAWINGS

Other aspects of the present disclosure will become apparent from the following description of embodiments with reference to the accompanying drawings in which:

FIG. 1 is a block diagram schematically illustrating an input/output system to/from a control apparatus of a vehicle according to the first embodiment;

FIG. 2 is a schematic plan view illustrating a first situation where a vehicle is traveling in accordance with a scheduled travel route on which multiple waypoints are located according to the first embodiment;

FIG. 3 is a diagram illustrating a correlation between (i) each multiple waypoint, (ii) a corresponding index ID, and (iii) a corresponding target vehicle speed;

FIG. 4 is a flowchart schematically illustrating a control routine to be carried out by a control apparatus according to the first embodiment;

FIG. 5 is a schematic plan view illustrating a second situation where the vehicle is traveling on the scheduled travel route on which the multiple waypoints are located according to the first embodiment;

FIG. 6 is a schematic plan view, which corresponds to FIG. 2, used to describe a method of determining whether the vehicle has reached a waypoint according to the second embodiment; and

FIG. 7 is a schematic plan view, which corresponds to FIG. 2, used to describe another method of determining whether the vehicle has reached a waypoint according to the third embodiment.

### DETAILED DESCRIPTION OF EMBODIMENTS

The following describes exemplary embodiments of the present disclosure with reference to accompanying drawings. In the following exemplary embodiments, substantially identical or equivalent components are represented by the same reference characters and redundant explanations are omitted.

### First Embodiment

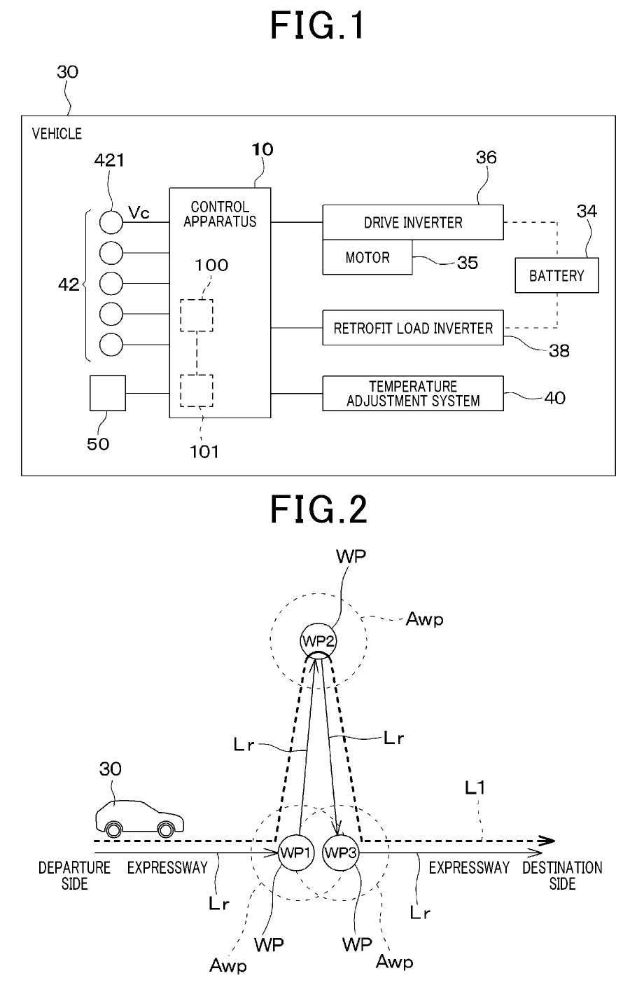

Referring to FIG. 1, a control apparatus 10 according to the first embodiment is a vehicular control apparatus applicable to, for example, a vehicle 30, such as an electric vehicle, 30. The electric vehicle as the vehicle 30 according to the first embodiment will also be referred to as a Battery Electric vehicle (BEV), and the vehicle (BEV) 30 does not include an engine, and includes a battery, i.e., a secondary battery, 34, and can travel based on power obtained from the battery 34.

The control apparatus 10 has a configuration as a microcomputer provided with a processor, i.e., a CPU, 100 and a storage 101 including, for example, a RAM, a ROM, and a non-volatile rewritable memory. The processor 100, serves as, for example, control circuitry, reads and executes computer programs, i.e., computer-program instructions, stored in the corresponding ROM or the non-volatile rewritable memory. Each of the ROM and the non-volatile rewritable memory serves as a non-transitory tangible storage medium. Executing the computer programs enables methods corresponding to the computer programs to be carried out.

That is, the processor 100 of the control apparatus 10 executes various control processes in accordance with the corresponding computer programs.

As illustrated in FIG. 1, the vehicle 30 according to the first embodiment includes, in addition to the control apparatus 10 and the battery 34, a motor 35, a drive inverter 36, an additional-load inverter 38, a temperature adjustment system 40, and multiple types of sensors 42.

The battery 34 is a rechargeable secondary battery, and is constituted by, for example, a lithium ion battery or a nickel-hydrogen battery or a nickel-metal-hydride battery. The battery 34 serves as a vehicle power supply that supplies current to each of various electric devices, which include the motor 35, the drive inverter 36, and the retrofit load inverter 38, installed in the vehicle 30.

The motor 35, which serves as a prime mover for the vehicle 30, is a traction motor that rotationally drives drive wheels of the vehicle 30. Specifically, the motor 35 is configured to receive electric power supplied from the drive inverter 36 to accordingly rotate the driving wheels of the vehicle 30, thus propelling the vehicle 30. The drive inverter 36 is configured to convert a direct current from the battery 34 into an alternating current, and supply the converted alternating current to the motor 35, thus rotating the motor 35.

The retrofit load inverter 38 is an inverter for supplying power to one or more electrical loads retrofittable to the vehicle 30, that is, retrofit electrical loads.

The retrofit load inverter 38 is configured to convert a voltage across the battery 34 into a voltage suitable for the one or more retrofit electrical loads, and supply power based on the converted voltage to the one or more retrofit electrical loads. For example, the one or more retrofit electrical loads may include household appliances, such as a portable refrigerator-freezer connected to an AC 100 V outlet provided in the vehicle 30.

The temperature adjustment system 40 includes a refrigeration cycle circuit in which a refrigerant is circulated, a water circuit in which a liquid medium such as cooling water is circulated, and at least one heat exchanger provided across both the water circuit and the refrigeration cycle circuit. The at least one heat exchanger causes the liquid medium in the water circuit to exchange heat with the refrigerant in the refrigeration cycle circuit.

The temperature adjustment system 40 includes an electric compressor. The electric compressor is controlled by the control apparatus 10 to operate so that the refrigerant is circulated in the refrigeration cycle circuit based on operation of the electric compressor, and the circulation of the refrigerant enables a vapor compression refrigeration cycle to be executed.

The water circuit system includes an electric pump. The electric pump is controlled by the control apparatus 10 to operate so that the liquid medium is circulated in the water circuit.

The temperature adjustment system 40 is configured such that execution of the vapor compression refrigeration cycle and circulation of the liquid medium in the water circuit enable adjustment of (i) the temperature of each of the battery 34, the motor 35, and the drive inverter 36 and (ii) the temperature of the conditioned air blown from an air conditioning unit of the vehicle 30 into a cabin of the vehicle 30.

The battery 34, the motor 35, the drive inverter 36, and the temperature adjustment system 40 described above are each electrically connected to the control apparatus 10.

The control apparatus 10 is configured to output control signals indicating to the controlled devices to accordingly control the controlled devices.

The various types of sensors 42, which includes a vehicle speed sensor 421 for measuring a speed Vc of the vehicle 30, are electrically connected to the control apparatus 10. Measurement signals from the sensors 42, each of which indicates the measurement of the corresponding sensor 42, are input to the control apparatus 10. The various types of sensors 42 include, for example, a cabin temperature sensor for measuring the temperature in the cabin, a battery temperature sensor for measuring the temperature of the battery 34, and an ambient air temperature sensor for measuring the temperature of ambient air around the vehicle 30.

The vehicle 30 of the first embodiment includes an interface unit 50 connected to the control apparatus 10. The interface unit 50 includes an input function of enabling one or more occupants of the vehicle 30 to input information to the control apparatus 10, and an output function of outputting information to the one or more occupants. Specifically, the control apparatus 10, i.e., the processor 100, of the first embodiment is configured to receive travel plan basic information inputted from the interface unit 50 through the occupant’s operation of the interface unit 50. Examples of the travel plan basic information include various information including a start point, i.e., departure, of the vehicle 30, a destination, and preference information indicating preferences of the occupants.

The processor 100 is configured to prepare a travel plan for causing the vehicle 30 to travel. That is, the travel plan has been prepared and determined by the control apparatus 10 before traveling of the vehicle 30.

In detail, the processor 100 of the control apparatus 10 is configured to establish a travel plan for the vehicle 30 based on the above-described travel plan basic information so as to reduce energy consumption and extend the driving range of the vehicle 30 while satisfying the occupant’s preferences as much as possible. The occupant’s preferences can be obtained, for example, from the preference information included in the travel plan basic information. The occupant’s preferences may include, for example, the strength level of the air conditioning in the cabin, and/or the state of charge (SoC) of the battery 34 at the time when the vehicle 30 arrives at the destination.

For example, the processor 100 of the control apparatus 10 may be configured to perform computer simulations based on (i) the travel plan basic information and, for example, (ii) the actual energy consumption performance of the vehicle 30 stored in the storage 101 to accordingly generate a plurality of travel-plan candidates. Then, the processor 100 of the control apparatus 10 may be configured to select, among the travel-plan candidates, one of the travel-plan candidates as the travel plan, which achieves the greatest reduction in energy consumption of the vehicle 30.

The term “SOC” is an abbreviation for “State of Charge.” The “energy consumption performance” of the vehicle 30 refers to the traveling distance per unit amount of electric energy consumed by the vehicle 30. Furthermore, the “actual energy consumption performance” of the vehicle 30 refers to the actual, continuously updated energy efficiency data recorded by the processor 100 of the control apparatus 10 in the storage 101 during traveling of the vehicle 30.

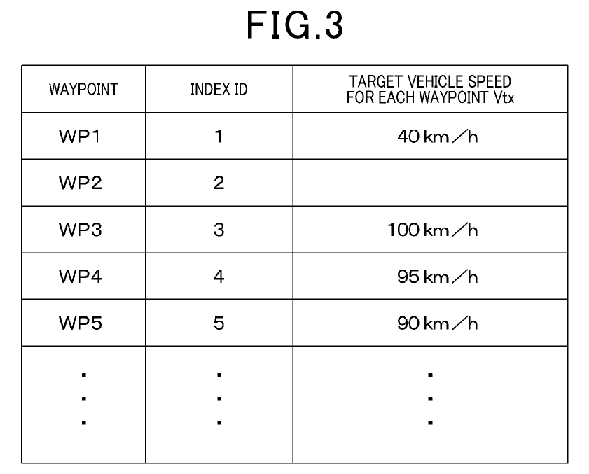

The determined travel plan PN is comprised of a plurality of information items including, for example, (i) a scheduled travel route Lr along which the vehicle 30 is controlled to travel from the start point (departure) to the destination, (ii) the positional information on each of multiple waypoints WP located on the scheduled travel route Lr, and (iii) a target vehicle speed Vtx corresponding to each waypoint WP. FIG. 2 illustrates an example of the scheduled travel route Lr, and FIG. 3 illustrates, as a table, an example of the target vehicle speed Vtx corresponding to each waypoint WP.

When distinguishing between the multiple waypoints WP, the following assigns reference numerals to the multiple waypoints WP in ascending order from the departure side to the destination side, as shown in FIGS. 2 and 3. Thus, the waypoints WP are denoted as waypoint WP1, waypoint WP2, waypoint WP3, and so on.

The table shown in FIG. 3 sequentially illustrates the waypoints WP1, WP2, WP3, … arranged along the scheduled travel toute Lr from the top side corresponding to the departure side to the bottom side corresponding to the destination side. For example, a waypoint immediately preceding the waypoint WP3 is the waypoint WP2, and a waypoint immediately preceding the waypoint WP2 is the waypoint WP1.

As illustrated in FIG. 2, for example, the waypoint WP1 corresponds to the entrance of a service area on an expressway, the waypoint WP3 corresponds to the exit of the service area, and the waypoint WP2 corresponds to a charging spot provided within the service area. The charging spot refers to a charging facility capable of supplying electric power to the battery 34 of the vehicle 30. The travel plan may include the amount of charge and the charging time for charging the battery 34 of the vehicle 30 at a charging spot included in the travel plan.

The determined travel plan is stored in the storage 101. That is, after the travel plan is determined, the storage 101 stores, in advance, the information items constituting the travel plan, such as the scheduled travel route Lr, the positions of the respective multiple waypoints WP, and the target vehicle speed Vtx corresponding to each of the multiple waypoints WP.

As illustrated in FIG. 3, multiple index IDs (index values) respectively correlate with the multiple waypoints WP are also stored in advance in the storage 101. These index IDs represent, in ascending order from the departure side, the sequence of the multiple waypoints WP located along the scheduled travel route Lr. For example, the index ID of the waypoint WP1 is set to “1,” so that the index ID of the waypoint WP2 is set to “2.”

Each time the vehicle 30, which has been started to travel in accordance with the determined travel plan, reaches each waypoint WP, the processor 100 of the control apparatus 10 updates the target vehicle speed Vt, which is the target value of a speed Vc of the vehicle 30, to a waypoint-corresponding target vehicle speed Vtx associated with the corresponding waypoint WP.

In addition, the processor 100 of the control apparatus 10 executes automatic control for automatically controlling the rotational speed of the motor 35, which is a control target of the control apparatus 10, such that the vehicle speed Vc approaches the target vehicle speed Vt.

Because the travel plan has been established so as to satisfy the occupant’s preferences as much as possible while reducing the energy consumption of the vehicle 30, the processor 100 of the control apparatus 10 executes this automatic control as control that adjusts the energy consumption of the vehicle 30 while the vehicle 30 travels along the scheduled travel route Lr. The energy consumption of the vehicle 30 refers to the consumption of the electric energy stored in the battery 34.

Each waypoint WP is expressed as position coordinates within a specified coordinate system, such as longitude and latitude. The speed Vc of the vehicle 30, which is also be referred to as a vehicle speed Vc, corresponds to, for example, a predetermined physical quantity of the present disclosure. The target vehicle speed Vt corresponds to, for example, a control target value of the present disclosure, and the motor 35 corresponds to, for example, a control target of the present disclosure. Additionally, the waypoint-corresponding target vehicle speed Vtx corresponds to, for example, a waypoint-corresponding target value of the present disclosure.

The vehicle 30 of the first embodiment is a vehicle capable of automatically controlling the speed Vc thereof. During execution of the travel plan, although the vehicle speed Vc is automatically controlled, the traveling direction of the vehicle 30 is, for example, not automatically controlled. Accordingly, guidance along the scheduled travel route Lr is automatically provided to the occupants, and the traveling direction of the vehicle 30 is operated by a driver of the occupants.

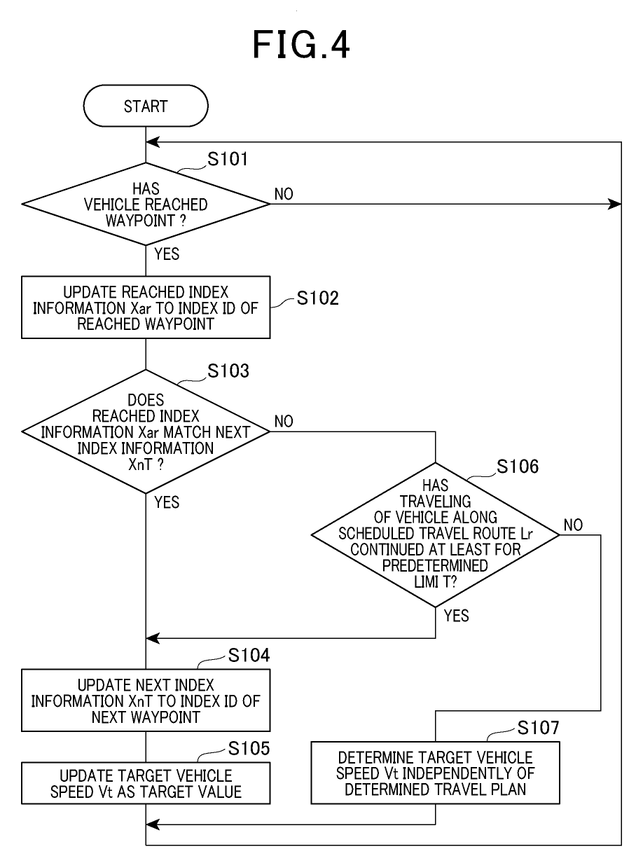

Each time the vehicle 30 reaches a waypoint WP, the processor 100 of the control apparatus 10 is configured to basically update, as described above, the target vehicle speed Vt to the waypoint-corresponding target vehicle speed Vtx associated with the reached waypoint WP. In particular, the processor 100 of the control apparatus 10 is configured to execute a control routine illustrated in FIG. 4 to accordingly perform a target vehicle-speed updating task. For example, traveling of the vehicle 30 in accordance with the determined travel plan is started in response to, for example, an occupant’s manual start operation through the interface unit 50, and the processor 100 is configured to start the control routine in response to the start of the traveling of the vehicle 300.

When starting the control routine, the processor 100 acquires the current position of the vehicle 30, i.e., the current vehicle position, in step S101. For example, the processor 100 may acquire the current vehicle position from a navigation apparatus and/or a GPS (Global Positioning System) included in the sensors 42.

Then, the processor 100 determines, based on the current vehicle position, whether the vehicle 30 has reached any one of the multiple waypoints WP in step S101.

In response to determination that the vehicle 30 has reached any one of the multiple waypoints WP in step S101, the processor 100 recognizes which of the multiple waypoints WP that the vehicle 30 has reached, and records the determination and recognition result in, for example, the storage 101 in step S101.

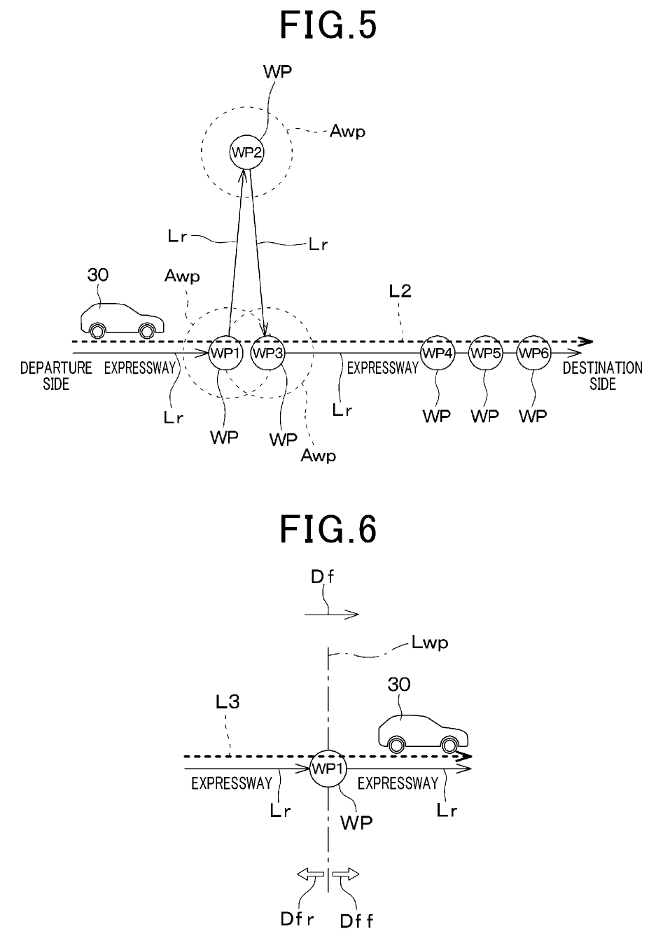

Specifically, as illustrated in FIGS. 2 and 5, a predetermined determination range Awp is established for each waypoint WP; the predetermined determination range Awp for each waypoint WP includes the corresponding waypoint WP and extends in a horizontal plane. Each determination range Awp for the corresponding waypoint WP is stored in the storage 101 of the control apparatus 10 while being associated with the corresponding waypoint WP.

For example, the determination range Awp for each waypoint WP is defined as a two-dimensional area that extends radially in a horizontal plane in the form of a circular shape centered on the corresponding waypoint WP to which the determination range Awp is associated.

That is, the processor 100 determines that the vehicle 30 has reached one of the waypoints WP upon determining that the current vehicle position enters the one of the waypoints WP in step S101. The determination range Awp for each waypoint WP may be experimentally defined, in light of road widths related to the scheduled travel route, as a range within which it can be determined that the vehicle 30 has reached the corresponding waypoint WP.

In response to determination that the vehicle 30 has reached one of the waypoints WP (YES in step S101), the control routine proceeds to step S102. Otherwise, in response to determination that the vehicle 30 has not reached any waypoint WP yet (NO in step S101), the processor 100 repeats the operation in step S101.

Following the affirmative determination in step S101, the processor 100 updates reached index information Xar to an index ID of the reached waypoint WP that the vehicle 30 is determined to have reached in step S102. For example, when it is determined that the vehicle 30 has reached the waypoint WP2, the processor 100 updates the reached index information Xar to the index ID “2” (Xar = 2), because the index ID “2” correlates with the waypoint WP2. Following the operation in step S102, the control routine proceeds to step S103.

In step S103, the processor 100 determines whether the reached index information Xar matches next index information Xnt.

The next index information Xnt represents information indicative of a waypoint WP that the vehicle 30 is scheduled to reach next, and is stored in the control apparatus 10, for example, in the storage 101.

The next index information Xnt is to be updated in step S104 described later, and an initial value of the next index information Xnt is set to the index value associated with the first waypoint WP on the scheduled travel route Lr. For example, when the first waypoint WP on the scheduled travel route Lr is the waypoint WP1 (see FIG. 3), the initial value of the next index information Xnt is “1”, because the index value associated with the waypoint WP1 is “1”. The next index information Xnt corresponds to, for example, index information according to the present disclosure.

In response to determination that the reached index information Xar matches the next index information Xnt (YES in step S103), the control routine proceeds to step S104. Otherwise, in response to determination that the reached index information Xar does not match the next index information Xnt (NO in step S103), the control routine proceeds to step S105.

In step S104, the processor 100 updates the next index information Xnt to the index ID of the next waypoint WP following the reached waypoint WP that the vehicle 30 is determined to have reached. For example, when it is determined in step S101 that the vehicle 30 has reached the waypoint WP2, the processor 100 updates the next index information Xnt to the index ID “3” (Xnt = 3), because the waypoint WP following the reached waypoint WP2 is the waypoint WP3 and index ID “3” correlates with the waypoint WP3. Following the operation in step S104, the control routine proceeds to step S105.

In step S105, the processor 100 updates the target vehicle speed Vt as the control target value for the vehicle speed Vc. Specifically, the processor 100 determines the waypoint-corresponding target vehicle speed Vtx associated with the waypoint WP that the vehicle 30 is determined to have reached in step S101.

For example, when it is determined in step S101 that the vehicle 30 has reached the waypoint WP3, the processor 100 updates the target vehicle speed Vt to 100 km/h, because, as illustrated in FIG. 3, the waypoint-corresponding target vehicle speed Vtx associated with the waypoint WP3 is 100 km/h. Then, the processor 100 controls the motor 35 as the control target to accordingly bring the vehicle speed Vc closer to the target vehicle speed Vt in step S105. Following the operation in step S105, the control routine returns to step S101.

Otherwise, in response to determination that the reached index information Xar does not match the next index information Xnt (NO in step S103), the processor 100 determines whether traveling of the vehicle 30 along the scheduled travel route Lr has continued at least for a predetermined limit up to the reached waypoint WP (i.e., the currently reached waypoint) that the vehicle 30 is determined to have reached in step S101 in step S106.

A case where traveling of the vehicle 30 along the scheduled travel route Lr has continued at least for the predetermined limit up to the currently reached waypoint WP is as follows.

That is, this case refers to a situation in which the vehicle 30 is determined, in step S101, to have reached the waypoints WP arranged along the scheduled travel route Lr in a scheduled order at least a predetermined number of times while the vehicle travel is being continued. In this case, “the determination that traveling of the vehicle 30 along the scheduled travel route Lr has continued at least for the predetermined limit up to the currently reached waypoint WP” means that, in step S101, it has been determined that the vehicle 30 has reached, in a scheduled order, the plurality of waypoints WP arranged along the scheduled travel route Lr at least the predetermined number of times.

In other words, determination as to whether traveling of the vehicle 30 along the scheduled travel route Lr has continued at least for the predetermined limit up to the currently reached waypoint WP means determination as to whether the number of waypoints WP, including the currently reached waypoint WP, that the vehicle 30 has passed in the predetermined order up to the currently reached waypoint WP along the scheduled travel route Lr is more than or equal to a predetermined threshold number while traveling of the vehicle 30 is being continued.

The predetermined number of times and the predetermined limit are experimentally defined in advance to enable determination as to whether traveling of the vehicle 30 along the scheduled travel route Lr is being continued. The predetermined number of times is set to 2 or more, and to 3 according to the first embodiment.

In response to determination that traveling of the vehicle 30 along the scheduled travel route Lr has continued at least for the predetermined limit up to the currently reached waypoint WP (YES in step S106), the control routine proceeds to step S104. Otherwise, in response to determination that traveling of the vehicle 30 along the scheduled travel route Lr has not continued at least for the predetermined limit up to the currently reached waypoint WP (NO in step S106), the control routine proceeds to step S107.

In step S107, the processor 100 determines the target vehicle speed Vt independently of the determined travel plan PN. Specifically, the processor 100 determines the target vehicle speed Vt independently of the waypoint-corresponding target vehicle speed Vtx associated with the currently reached waypoint WP in step S107. For example, the processor 100 of the first embodiment maintains the target vehicle speed Vt unchanged. Following the operation in step S107, the control routine returns to step S101.

The sequential operations in steps S101, S102, S103, S104, and S105 result in the next index information Xnt and the target vehicle speed Vt being updated as described hereinafter. Specifically, when it is determined in step S101 that the vehicle 30 has reached an arbitrary waypoint in the multiple waypoints WP, the next index information Xnt is updated in step S104 and the target vehicle speed Vt is updated in step S105 when a predetermined update condition is satisfied. The predetermined update condition is that, in a previous step S101, it has already been determined that the vehicle 30 has reached a previous waypoint, which is the waypoint immediately preceding the arbitrary waypoint on the scheduled travel route Lr, and that the next index information Xnt has been updated in response to that determination.

In other words, the predetermined update condition is:

(I) that the vehicle 30 has reached the previous waypoint, which precedes the arbitrary waypoint on the scheduled travel route Lr; and

(II) that the next index information Xnt matches the index ID associated with the arbitrary waypoint.

In connection with the above, the following describes a first example case where the waypoint WP3 in FIG. 2 corresponds to the above-mentioned arbitrary waypoint, and the vehicle 30 travels along an actual travel route L1 shown in FIG. 2.

In this first example case, when it is determined in step S101 that the vehicle 30 has reached the waypoint WP3, the predetermined update condition is that, in the previous step S101, it has already been determined that the vehicle 30 has reached the waypoint WP2 that is the previous waypoint immediately preceding the arbitrary waypoint WP3, and that the next index information Xnt has been updated in response to that determination.

As illustrated in the actual travel route L1 shown in FIG. 2, because the vehicle 30 has reached the waypoint WP3 after passing through the waypoint WP2, it has already been determined that the vehicle 30 has reached the waypoint WP2 in the previous step S101, and the next index information Xnt has been updated to the index ID associated with the waypoint WP3 in response to the determination in the previous step S101.

That is, in this first example case, the predetermined update condition is satisfied. Specifically, when the vehicle 30 has reached the waypoint WP2 in the previous step S101, the next index information Xnt has been updated to the index ID associated with the waypoint WP3 in step S104 in response to the determination in the previous step S101. This results in the determination in step S103 after the determination in step S101 that the vehicle 30 has reached the waypoint WP3 becoming YES, so that the next index information Xnt is updated to the index ID associated with the next waypoint WP4 next to the waypoint WP3 in step S104 following step S103. Then, the target speed Vt is updated to the waypoint-corresponding target speed Vtx associated with the waypoint WP3.

In contrast, the following describes a second example case where the waypoint WP3 in FIG. 2 corresponds to the above-mentioned arbitrary waypoint, and the vehicle 30 travels along an actual travel route L2 shown in FIG. 5. The outcome of this second example case differs from that of the first example case.

In this second example case, when it is determined in step S101 that the vehicle 30 has reached the waypoint WP3, the waypoint WP2 that is the previous waypoint immediately preceding the arbitrary waypoint WP3 and the predetermined update condition is the same as that in the first example case.

As illustrated in the actual travel route L2 shown in FIG. 5, because the vehicle 30 has not reached the waypoint WP2, i.e., has not passed through the waypoint WP2, the predetermined update condition is not satisfied. In other words, in the previous step S101 before it is determined that the vehicle 30 has reached the arbitrary waypoint WP3 in current step S101, it is not determined that the vehicle 30 has reached the previous waypoint WP2 but determined that the vehicle 30 has reached the waypoint WP1. For this reason, in step S103 after the determination in step S101 that the vehicle 30 has reached the waypoint WP3, it is determined that the reached index information Xar does not match the next index information Xnt. Specifically, at the determination in step S103, the reached index information Xar is 3 (Xar = 3), and the next index information Xnt is 2 (Xnt =2). This results in, after it is determined that the vehicle 30 has reached the waypoint WP3 in step S101, the operations in steps S104 and S105 being not performed.

Like the second example case, in a third example case where the waypoint WP4 in FIG. 2 corresponds to the above-mentioned arbitrary waypoint, and the vehicle 30 travels along the actual travel route L2 shown in FIG. 5, the outcome of the third example case results in the operations in steps S104 and S105 being not performed.

In this third example case, when it is determined in step S101 that the vehicle 30 has reached the waypoint WP4, the waypoint that is the previous waypoint immediately preceding the arbitrary waypoint WP4 is the waypoint WP3. When it is determined in step S101 that the vehicle 30 has reached the waypoint WP3, the determination in step S104 is not performed, so that the next index information Xnt is not updated.

That is, let us assume that the predetermined update condition is comprised of

(i) A first item that, in the previous step S101, it has already been determined that the vehicle 30 has reached the previous waypoint, which is the waypoint immediately preceding the arbitrary waypoint on the scheduled travel route Lr, and

(ii) A second item that the next index information Xnt has been updated in response to that determination.

In this assumption, in the third example case, the second item of the predetermined update condition, which is that the next index information Xnt has been updated in response to the determination in the previous S101 that the vehicle 30 has reached the previous waypoint WP3, is not satisfied.

Specifically, this is because, in step S103 after the determination in step S101 that the vehicle 30 has reached the waypoint WP4, it is determined that the reached index information Xar does not match the next index information Xnt. That is, at the determination in step S103, the reached index information Xar is 4 (Xar = 4), and the next index information Xnt is 2 (Xnt =2).

The sequential operations in steps S101, S102, S103, S106, S104, and S105 result in the next index information Xnt and the target vehicle speed Vt being updated as described hereinafter. Specifically, when it is determined in step S101 that the vehicle 30 has reached an arbitrary waypoint in the multiple waypoints WP, the operations in steps S104 and S105 are performed when traveling of the vehicle 30 along the scheduled travel route Lr has continued at least for the predetermined limit up to the arbitrary waypoint. This results in the next index information Xnt being updated in step S104 and the target vehicle speed Vt being updated to the waypoint-corresponding target vehicle speed Vtx associated with the arbitrary waypoint in step S105.

In connection with the above, the following describes a fourth example case where the waypoint WP5 in FIG. 5 corresponds to the above-mentioned arbitrary waypoint, and the vehicle 30 travels along the actual travel route L2 shown in FIG. 5.

In this fourth example case, when it is determined in step S101 that the vehicle 30 has reached the waypoint WP5, the determination result in each previous step S101 has become YES at the arrival of the vehicle 30 at the corresponding one of the waypoints WP3, WP4, and WP5.

Accordingly, it is determined that the vehicle 30 has reached, in the scheduled order, at least the predetermined number of waypoints WP (specifically, three or more) arranged along the scheduled travel route Lr, while the traveling of the vehicle 30 is being continued.

In other words, as described in connection with step S106, this means that the traveling of the vehicle 30 along the scheduled travel route Lr has been continued for at least the predetermined limit up to the above-mentioned arbitrary waypoint (specifically, the waypoint WP5).

That is, in this fourth example case, the next index information Xnt is updated to the index ID associated with the next waypoint (specifically, the waypoint WP6) next to the waypoint WP5, and the target speed Vt is updated to the waypoint-corresponding target speed Vtx correlating with the arbitrary waypoint WP5.

In contrast, the following describes a fifth example case where the vehicle 30, which is traveling on the actual travel route L2 shown in FIG. 5, reaches the waypoint WP3 or the waypoint WP4 in FIG. 5.

In this fifth example case, when it is determined in step S101 that the vehicle 30 has reached the waypoint WP3, the number of times it is determined that the vehicle 30 has reached the waypoints WP arranged along the scheduled travel route Lr in the scheduled order — that is, the ordered waypoint reach count — is one. This is because, as shown by the actual travel route L2 in FIG. 5, the vehicle 30 has reached the waypoint WP2 without passing through the waypoint WP2, so that the ordered waypoint reach count corresponds to one occurrence of reaching the waypoint WP3.

Additionally, at the time when it is determined in step S101 that the vehicle 30 has reached the waypoint WP4, the ordered waypoint reach count is two, corresponding to the vehicle 30 having reached the waypoints WP3 and WP4.

In either situation where it is determined in step S101 that the vehicle 30 has reached the waypoint WP3 or it is determined in step S101 that the vehicle 30 has reached the waypoint WP4, the ordered waypoint reach count is less than the predetermined number (specifically, less than three). For this reason, each situation does not correspond to the case where the traveling of the vehicle 30 along the scheduled travel route Lr has been continued for at least the predetermined limit up to the arbitrary waypoint. Accordingly, in each situation, the operations in steps S104 and S105 are not executed, and therefore the operation in step S107 is executed instead.

Note that the operation in each step illustrated in FIG. 4 constitutes, for example, a functional unit that implements a function corresponding to the operation. For example, the operation in step S101 corresponds to an arrival determination unit, the operation in step S105 corresponds to, for example, an index updating unit. The control apparatus 10, i.e., the processor 100, functionally includes the arrival determination unit and the index updating unit.

As described above, the control apparatus 10 according to the first embodiment is configured to operate the motor 35 as a control target included in the vehicle 30 that travels along the scheduled travel route Lr and automatically control, based on the operation of the motor 35, a predetermined physical quantity so as to bring the predetermined physical quantity closer to a control target value, thus adjusting energy consumption of the vehicle 30.

In particular, the control apparatus 10 is configured to determine, as illustrated in FIGS. 3 and 4, whether the vehicle 30 has reached an arbitrary waypoint WP included in the multiple waypoints WP on the scheduled travel route Lr, and determine, in response to determination that the vehicle 30 has reached the arbitrary waypoint WP, the waypoint-corresponding target vehicle speed Vxt associated with the arbitrary waypoint WP as the target vehicle speed Vt.

Accordingly, the control apparatus 10, which adjusts the vehicle speed Vc at each waypoint WP on the scheduled travel route Lr, makes it possible to dynamically adjust energy consumption of the vehicle 30 in accordance with a travel progress of the vehicle 30 along the scheduled travel route Lr.

That is, the control apparatus 10 is capable of dynamically adjusting energy consumption of the vehicle 30 in accordance with how far the vehicle 30 has traveled along the scheduled travel route Lr, making it possible to achieve both the securing of occupant comfort and the reduction of energy consumption of the vehicle 30.

In response to determination that the vehicle 30 has reached an arbitrary waypoint WP included in the multiple waypoints WP in step S101, the control apparatus 10 updates the next index information Xnt in step S104 when the predetermined update condition is satisfied. Additionally, following the operation in step S104, the control apparatus 10 determines, in step S105, determines the waypoint-corresponding target vehicle speed Vtx associated with the arbitrary waypoint WP as the target vehicle speed Vt. The predetermined update condition is that, in a previous step S101, it has already been determined that the vehicle 30 has reached a previous waypoint, which is the waypoint immediately preceding the arbitrary waypoint on the scheduled travel route Lr, and that the next index information Xnt has been updated in response to that determination.

This configuration of the control apparatus 10 makes it possible to update the target vehicle speed Vt to the waypoint-corresponding target vehicle speed Vrx for each of the waypoints WP sequentially arranged along the scheduled travel route Lr.

For example, in the example illustrated in FIG. 2, because the waypoint WP1 and the waypoint WP3 are located close to each other, it may be assumed that the vehicle 30 is determined to have arrived at the waypoint WP3 before the waypoint WP1 in step S101.

However, even if the above determination in step S101 is carried out, the above configuration of the control apparatus 10 prevents the target vehicle speed Vt from being updated to the waypoint-corresponding speed Vtx associated with the waypoint WP3, because the predetermined update condition is not satisfied.

Additionally, let us assume a case where, when, after it has been repeatedly determined in step S101 that the vehicle 30 has reached the waypoints WP up to the waypoint WP2 in the scheduled order along the scheduled travel route Lr, it is determined in the next step S101 that the vehicle 30 has reached the waypoint WP3. In this case, the above-described predetermined update condition is satisfied.

This therefore enables the control apparatus 10 to update the target vehicle speed Vt to the waypoint-corresponding target speed Vtx associated with the waypoint WP3 in step S105 after it is determined in step S101 that the vehicle 30 has reached the waypoint WP3.

Accordingly, the control apparatus 10 makes it possible to update the target vehicle speed Vt to the waypoint-corresponding target vehicle speed Vrx for each of the waypoints WP sequentially arranged along the scheduled travel route Lr. Additionally, the control apparatus 10 makes it possible to avoid updating of the target vehicle speed Vt based on erroneous determination that the vehicle 30 has reached a waypoint due to, for example, false information on the current position of the vehicle 30.

When it is determined in step S101 that the vehicle 30 has reached an arbitrary waypoint WP in the multiple waypoints WP, in response to determination that traveling of the vehicle 30 along the scheduled travel route Lr has continued at least for the predetermined limit up to the arbitrary waypoint WP, the control routine proceeds as follows. Specifically, in this case, independently of the predetermined update condition, the next index information Xnt is updated in step S104, and the waypoint-corresponding target vehicle speed Vtx is determined as the target vehicle speed Vt in the next step S105.

In a case where the vehicle 30 has traveled at or beyond the waypoint WP3 without reaching, i.e., passing through, the waypoint WP2 as illustrated by the actual travel route L2, the above configuration of the control apparatus 10 makes it possible to perform updating of the target vehicle speed Vt after the vehicle 30 has traveled a certain distance. That is, the above configuration of the control apparatus 10 makes it possible to avoid a situation where the target vehicle speed Vt is maintained without being updated for a long time after the waypoint WP3.

In the above case the vehicle 30 has traveled at or beyond the waypoint WP3 without passing through, the waypoint WP2, rerouting of the scheduled travel route Lr is not carried out. This therefore improves the usability and convenience for the driver as compared with a case in which such a rerouting is carried out.

The control apparatus 10 of the first embodiment is configured to determine, in step S106, whether traveling of the vehicle 30 along the scheduled travel route Lr has continued at least for the predetermined limit up to the reached waypoint WP (i.e., the currently reached waypoint) that the vehicle 30 is determined to have reached in step S101 in step S106.

A case where traveling of the vehicle 30 along the scheduled travel route Lr has continued at least for the predetermined limit up to the currently reached waypoint WP is as follows.

That is, this case refers to a situation in which the vehicle 30 is determined, in step S101, to have reached the waypoints WP arranged along the scheduled travel route Lr in the planned order at least the predetermined number of times while the vehicle travel is being continued.

Accordingly, the processor 100 refers to the history of the determination and recognition results, each of which represents whether the vehicle 30 has reached a waypoint WP, recorded in the storage 101 to accordingly easily perform the determination in step S106.

The control apparatus 10 of the first embodiment is configured to determine that the vehicle 30 has reached a waypoint WP in response to determination that the current position of the vehicle 30 enters the predetermined determination range Awp, which includes the waypoint WP and is defined for the waypoint WP. Accordingly, this configuration of the control apparatus 10 makes it possible to absorb variations in the current position of the vehicle 30 caused by factors such as variations in the road widths related to the scheduled travel route Lr and vehicle’s position detection errors, thus determining whether the vehicle 30 has reached a waypoint WP in accordance with the actual vehicle travel.

### Second embodiment

Next, the following describes the second embodiment. In particular, the following mainly describes different points of the second embodiment, which are different from the first embodiment.

The description of the same or equivalent components as those in the aforementioned first embodiment will be omitted or simplified. This also applies to the description of the later-described embodiments and modifications.

The method of determining whether the vehicle 30 has reached a waypoint WP according to the second embodiment differs from that according to the first embodiment.

Specifically, no determination ranges Awp illustrated in FIG. 2 are provided. In place of the determination ranges Awp, virtual threshold lines Lwp, i.e., their positional information items, are established to correlate with the respective waypoints WP and the positional information items of the respective virtual threshold lines Lwp are stored in the storage 101.

Each virtual threshold line Lwp is a virtual straight line extending horizontally, intersecting the traveling direction Df of the vehicle 30. Technically speaking, each virtual threshold line Lwp is a virtual straight line extending horizontally and perpendicularly to the traveling direction Df of the vehicle 30. Each virtual threshold line Lwp passes through the corresponding waypoint WP to partition the traveling direction Df into a forward direction side Dff and a reverse direction side Dfr, with a boundary defined by the corresponding waypoint WP. The traveling direction Df of the vehicle 30 may be referred to as a vehicle traveling direction Df.

In step S101, the processor 100 determines whether the current vehicle position moves from the reverse direction side Dfr to the forward direction side Dff across each of the virtual threshold lines Lwp, and determines that the vehicle 30 has reached one of the waypoints WP upon determining that the current vehicle position moves from the reverse direction side Dfr to the forward direction side Dff across the virtual threshold line Lwp of the one of the waypoints WP.

For example, when the vehicle 30 traveling along a traveling route L3 illustrated in FIG. 6 moves across a virtual threshold line Lwp from the reverse direction side Dfr to the forward direction side Dff of the virtual threshold line Lwp, the control apparatus 10 determines that the vehicle 30 has reached the waypoint WP corresponding to the virtual threshold line Lwp in step S101.

The second embodiment is substantially identical to the first embodiment except for the above description. The second embodiment achieves the same advantageous benefits as those achieved by the first embodiment set forth above.

### Third embodiment

Next, the following describes the third embodiment. In particular, the following mainly describes different points of the third embodiment, which are different from the first embodiment.

The processor 100 according to the third embodiment determines, in step S101, whether the current vehicle position enters any of the determination ranges Awp, and determines that the vehicle 30 has reached a waypoint WP upon determination that the current vehicle position enters one of the determination ranges Awp, which corresponds to the waypoint WP. This determination method is identical to the determination method according to the first embodiment.

In particular, the shape of each determination range Awp is different from that according to the first embodiment.

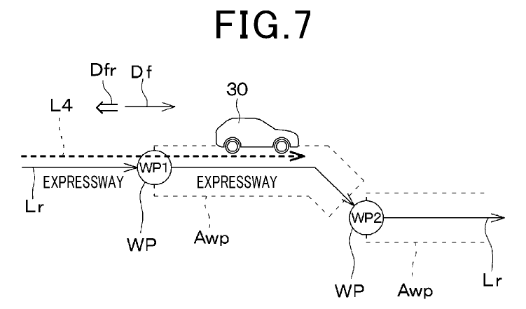

Specifically, as illustrated in FIG. 7, the determination range Awp for each waypoint WP is defined as a two-dimensional area that includes the corresponding waypoint WP, has a predetermined width in a direction perpendicular to the scheduled travel route Lr, and extends along the scheduled travel route Lr. Additionally, the determination range Awp for each waypoint WP is defined such that the corresponding waypoint WP is located at a rear-side end of the determination range Awp in the reverse direction side Dfr of the vehicle traveling direction Df. The width of the determination range Awp for each waypoint WP is determined based on a value calculated by, for example, multiplying the road width or the number of lanes of the corresponding waypoint WP by a predetermined coefficient.

Additionally, the determination range Awp for each waypoint WP is defined not to overlap the other adjacent determination ranges Awp.

For example, when the current position of the vehicle 30 traveling along a traveling route L4 illustrated in FIG. 7 enters the determination range Awp associated with the waypoint WP1, the processor 100 determines that the vehicle 30 has reached the waypoint WP1 in step S101.

The third embodiment is substantially identical to the first embodiment except for the above description. The third embodiment achieves the same advantageous benefits as those achieved by the first embodiment set forth above.

### Modifications

The vehicle 30 according to each of the first to third embodiments illustrated in FIG. 1 is an electric vehicle, which is an example. Specifically, the vehicle 30 may be one of a hybrid vehicle or a plug-in hybrid vehicle equipped with an internal combustion engine in addition to the motor 35 as a driving power source. The vehicle 30 may be an engine vehicle equipped with an internal combustion engine serving as only the driving power source.

If the vehicle 30 is a hybrid vehicle or a plug-in hybrid vehicle, the control target for the traveling control of the vehicle is the internal combustion engine and the motor 35. If the vehicle 30 is an engine vehicle, the control target for the traveling control of the vehicle is the internal combustion engine.

The control apparatus 10 is, as illustrated in FIG. 1, installed in the vehicle 30, which is an example. Specifically, a part or whole of the control apparatus 10 may be implemented in an external terminal wirelessly connectable for data communication to the vehicle 30 or in a cloud, i.e., a cloud server, wirelessly connectable for data communication to the vehicle 30. Such an external terminal may be comprised of a portable computer, such as a tablet or a smartphone, operable by the one or more occupants of the vehicle 30.

The processor 100 of each embodiment maintains the target vehicle speed Vt unchanged in step S107, which is an example. Specifically, as illustrated in FIG. 5, when it is determined in step S101 that the vehicle 30 traveling along the actual travel route L2 has reached the waypoint WP3, the sequential operations in steps S102, S103, S106, and S107 following the operation in step S101 are carried out. In this case, the processor 100 may update, in step S107, the target vehicle speed Vt to the waypoint-corresponding target vehicle speed Vtx associated with a waypoint immediately before the waypoint WP1.

The processor 100 according to each embodiment determines whether traveling of the vehicle 30 along the scheduled travel route Lr has continued at least for the predetermined limit up to the reached waypoint WP (i.e., the currently reached waypoint) that the vehicle 30 is determined to have reached in step S101 in step S106.

The first embodiment has described an example of the predetermined limit. Other examples of the predetermined limit may be used.

For example, there is an example where the vehicle 30 is traveling along the actual traveling route L2 illustrated in FIG. 5. In this example, the processor 100 may determine whether traveling of the vehicle 30 along the scheduled travel route Lr has continued at least for a predetermined determination period by the time when the vehicle 30 is determined to have reached in step S101 in step S106. The determination period may be variable depending on the vehicle speed Vc and/or the relative distances among the waypoints WP.

In the second embodiment, no determination ranges Awp illustrated in FIG. 2 are provided. In place of the determination ranges Awp, the virtual threshold lines Lwp are established to correlate with the respective waypoints WP, which is an example.

Both the determination range Awp and the virtual threshold line Lwp may be established to correlate with each waypoint WP. In this modification, the processor 100 may determine in step S101 whether (i) the current vehicle position moves from the reverse direction side Dfr to the forward direction side Dff across each of the virtual threshold lines Lwp and (ii) the current vehicle position enters the determination range Awp, and determine in step S101 that the vehicle 30 has reached one of the waypoints WP upon determining that (i) the current vehicle position moves from the reverse direction side Dfr to the forward direction side Dff across the virtual threshold line Lwp of the one of the waypoints WP and (ii) the current vehicle position enters the determination range Awp of the one of the waypoints WP.

The vehicle speed Vc according to each embodiment corresponds to the predetermined physical quantity according to the present disclosure, which is an example. Specifically, the temperature of the battery 34, the temperature in the cabin of the vehicle 30, which is to be adjusted by the temperature adjustment system 40, or the output to the one or more electrical loads retrofittable to the vehicle 30 may be used as the predetermined physical quantity according to the present disclosure.

In a case where the temperature of the battery 34 is automatically controlled so as to approach a control target value for the temperature of the battery 34, the control target is the temperature control system 40. Similarly, in a case where the cabin temperature is automatically controlled so as to approach a control target value for the cabin temperature, the control target is also the temperature control system 40. Additionally, in a case where the output to the one or more electrical loads retrofittable to the vehicle 30 is automatically controlled so as to approach a control target value for the output, the control target is the retrofit load inverter 38.

In each embodiment, the processor 100 determines, based on the current position of the vehicle 30 obtained from the navigation apparatus or the GPS, whether the vehicle 30 has reached any of the multiple waypoints WP in step S101, which is an example. For example, the control apparatus 10 may alternatively determine whether the vehicle 30 has reached any of the multiple waypoints WP based on external information obtained from outside the vehicle 30. Examples of such external information include, for example, image information from surveillance cameras installed around the respective waypoints WP, and satellite images, each of which shows an area around each waypoint WP, captured by an artificial satellite.

In each embodiment, as shown in FIG. 2, the scheduled travel route Lr is an expressway. However, the control routine illustrated in FIG. 4 may be executed while the vehicle 30 is traveling on an expressway, or alternatively while the vehicle 30 is traveling on an ordinary road.

The operation in each step illustrated in the flowchart of FIG. 4, which is implemented by one or more computer programs, may be implementable by hardware.

While the illustrative exemplary embodiments of the present disclosure have been described herein, the present disclosure is not limited to the exemplary embodiments and their configurations described herein. Specifically, the present disclosure includes various modifications and/or alternatives within the scope of the present disclosure.

One or more components in each of the exemplary embodiments are not necessarily essential components except for (i) one or more components that are described as one or more essential components or (ii) one or more components that are essential in principle.

Specific values disclosed in each of the exemplary embodiments, each of which represents the number of components, a physical quantity, and/or a range of a physical parameter, are not limited thereto except that (i) the specific values are obviously essential or (ii) the specific values are essential in principle.

In the exemplary embodiments, any mention of the materials, shapes, relative positions, etc., of components is not intended to be limiting, unless otherwise specified or where inherently limited by principle.

Sensors for acquiring external environmental information of the vehicle 30 (e.g., an outside air temperature) described in each of the embodiments may be omitted, and the external environmental information may instead be received from an external server of the vehicle 30 or from a cloud, i.e., a cloud server. The sensors may alternatively be omitted, and the vehicle 30 may obtain related information associated with the external environmental information from an external server or the cloud and estimate the external environmental information based on the obtained related information.

The control apparatus 10 according to the present disclosure includes multiple control functional units, such as the arrival determination unit and the index updating unit, which execute the operations in steps included in the flowchart of FIG. 4. The control functional units and their methods described in the present disclosure may be implemented by a dedicated computer including a memory and a processor configured to execute one or more functions realized by one or more computer programs. The control functional units and their methods may also be implemented by a dedicated computer provided by one or more dedicated hardware logic circuits that configure the processor. The control functional units and their methods may further be implemented by a dedicated computer configured by a combination of (i) a memory and a processor programmed to execute one or more functions and (ii) a processor configured by one or more hardware logic circuits. The computer programs may be stored, as instructions to be executed by a computer, in a non-transitory tangible storage medium that is readable by the computer.

As used herein, “control circuitry” encompasses hardware implemented to perform the described functions, including one or more processors executing instructions, digital logic such as ASICs (“Application Specific Integrated Circuits”) and FPGAs (“Field Programmable Gate Arrays”), or combinations thereof. The phrase “configured to” is used to denote structure arranged to perform the recited function during operation and is not intended to invoke 35 U.S.C. §112(f) absent express “means for” language.

The control circuitry may be implemented in or as part of any one or more of the control apparatus 10, an external terminal wirelessly connectable for data communication to the vehicle 30, or a cloud, i.e., a cloud server, wirelessly connectable for data communication to the vehicle 30. In certain embodiments, different portions of the control circuitry execute on different components and collectively implement the functions described herein.

The control circuitry may be configured to cause an appropriate portion of the control apparatus 10 to execute one or more functions as recited in each claim. Such configurations include implementations in which the control circuitry itself executes some or all of the claimed functions.

1. A control apparatus configured to operate a control target included in a vehicle that travels along a scheduled travel route and to automatically control, based on an operation of the control target, a predetermined physical quantity so as to bring the predetermined physical quantity closer to a control target value, thus adjusting energy consumption of the vehicle, the control apparatus comprising
a storage configured to store, in advance, at least one waypoint located on the scheduled travel route and a waypoint-corresponding target value associated with the at least one waypoint; and
control circuitry configured to cause the control apparatus to:
determine whether the vehicle has reached the at least one waypoint; and
determine the waypoint-corresponding target value as the control target value in response to determination that the vehicle has reached the at least one waypoint.

2. The control apparatus according to claim 1, wherein:
the at least one waypoint comprises multiple waypoints located on the scheduled travel route;
the storage is configured to store, in advance, each of the multiple waypoints located on the scheduled travel route and the waypoint-corresponding target value associated with each of the multiple waypoints; and
the control circuitry is configured to cause the control apparatus to:
determine whether the vehicle has reached one of the multiple waypoints; and
determine, in response to determination that the vehicle has reached one of the multiple waypoints, the waypoint-corresponding target value associated with the one of the multiple waypoints as the control target value.

3. The control apparatus according to claim 2, wherein:
next index information is stored in the control apparatus, the next index information representing a waypoint that the vehicle is scheduled to reach next;
the control circuitry is configured to cause, in response to determination that the vehicle has reached an arbitrary waypoint in the multiple waypoints, the control apparatus to:
update the next index information to an index value associated with a next waypoint next to the arbitrary waypoint when a predetermined update condition is satisfied,
the predetermined update condition being that (I) the vehicle has reached a previous waypoint, which precedes the arbitrary waypoint on the scheduled travel route; and (II) the next index information matches an index value associated with the arbitrary waypoint.

4. The control apparatus according to claim 3, wherein:
the control circuitry is configured to cause, in response to determination that the vehicle has reached the arbitrary waypoint in the multiple waypoints, the control apparatus to:
update, upon determination that traveling of the vehicle has continued at least for a predetermined limit up to the arbitrary waypoint, the next index information to the index value associated with the next waypoint independently of the predetermined update condition; and
determine the waypoint-corresponding target value associated with the arbitrary waypoint as the control target value.

5. The control apparatus according to claim 4, wherein:
a case where traveling of the vehicle has continued at least for the predetermined limit up to the arbitrary waypoint refers to a situation in which the vehicle is determined to have reached one of the multiple waypoints arranged along the scheduled travel route in a scheduled order at least a predetermined number of times while the traveling of the vehicle travel is being continued.

6. The control apparatus according to claim 1, wherein:
the control circuitry is configured to cause the control apparatus to determine whether the vehicle has reached one of the multiple waypoints in response to determination that a current position of the vehicle enters a predetermined determination range that includes the one of the waypoints.

7. The control apparatus according to claim 2, wherein:
next index information is stored in the control apparatus, the next index information representing a waypoint that the vehicle is scheduled to reach next;
the control circuitry is configured to cause the control apparatus to:
update, in response to determination that the vehicle has reached each waypoint, reached index information to an index value associated with the corresponding waypoint;
determine, in response to determination that the vehicle has reached an arbitrary waypoint in the multiple waypoints, whether the reached index information matches the next index information;
update, in response to determination that the reached index information matches the next index information, the next index information to an index value associated with a next waypoint next to the arbitrary waypoint; and
determine, in response to determination that the reached index information matches the next index information, the waypoint-corresponding target value associated with the arbitrary waypoint as the control target value.

8. A program product for a vehicle that travels along a scheduled travel route, the program product comprising:
a non-transitory storage medium; and
computer-program instructions stored in the non-transitory storage medium,
the computer-program instructions causing a processor to:
determine whether the vehicle has reached at least one waypoint located on the scheduled travel route;
read, from a storage in which the at least one waypoint and a waypoint-corresponding target value are stored to be associated with one another, the waypoint-corresponding target value in response to determination that the vehicle has reached the at least one waypoint;
determine the waypoint-corresponding target value as a control target value;
operate a control target included in the vehicle; and
automatically control, based on an operation of the control target, a predetermined physical quantity so as to bring the predetermined physical quantity closer to the control target value, thus adjusting energy consumption of the vehicle.

9. A method of controlling a vehicle that travels along a scheduled travel route, the method comprising:
determining whether the vehicle has reached at least one waypoint located on the scheduled travel route;
reading, from a storage in which the at least one waypoint and a waypoint-corresponding target value are stored to be associated with one another, the waypoint-corresponding target value in response to determination that the vehicle has reached the at least one waypoint;
determining the waypoint-corresponding target value as a control target value;
operating a control target included in the vehicle; and
automatically controlling, based on an operation of the control target, a predetermined physical quantity so as to bring the predetermined physical quantity closer to the control target value, thus adjusting energy consumption of the vehicle.
